(19) United States
(12) Patent Application Publication
(10) Pub. No.: US 2009/0145261 A1
(43) Pub. Date: Jun. 11, 2009

(54) Single mass dual mode crankshaft damper with tuned hub

(76) Inventor: Richard Obeshaw, Coldwater, MI (US)

Correspondence Address: MCDONALD HOPKINS LLC, 600 Superior Avenue, East, Suite 2100, CLEVELAND, OH, 44114-2653, US

(21) Appl. No.: 12/082,442

(22) Filed: Apr. 11, 2008

Related U.S. Application Data
(60) Provisional application No. 60/992,822, filed on Dec. 6, 2007.

(51) Int. Cl. F16F 15/12

(52) U.S. Cl. 74/574.4

(57) ABSTRACT

A damper for attachment to a crankshaft of an engine is provided. The damper has a hub member, an inertia member spaced radially outward from the hub member and an elastomer positioned between the hub member and the inertia member. The hub member has an opening for attachment to the crankshaft and extends at an angle away from the opening such that the inertia member is offset from the opening of the hub member. The offset inertia member prevents amplification of noise from the crankshaft. The elastomer has a curvature to improve dampening of bending vibrations.

### CROSS-REFERENCE TO RELATED APPLICATIONS

This application claims priority from U.S. Provisional Patent Application No. 60/922,822 entitled “SINGLE MASS DUAL MODE CRANKSHAFT DAMPER WITH TUNED HUB,” filed on Apr. 11, 2007, which is hereby incorporated by reference in its entirety.

### FIELD OF THE INVENTION

The present invention relates generally to a damper, and more particularly to a damper that reduces vibrations and noise of an internal combustion engine.

### BACKGROUND OF THE INVENTION

As is well known in the art, internal combustion engines are used to drive automobiles and other vehicles. Typically, the reciprocating operation of the cylinders in an internal combustion engine generates power that is transmitted to wheels of the vehicle through a crankshaft. The engine has a cylinder head consisting of numerous cylinders where a sequential explosion of gases in the cylinders drives the crank shaft. One end of the crankshaft may be used to drive the wheels, and the other end may be used to drive various auxiliary devices of the engine, such as an alternator, power steering and an air conditioning compressor.

However, the rotation and torque on the crankshaft causes many modes of unwanted vibrations. For example, torsional and bending vibrations produce distinct modes of vibration. Torsional vibration occurs angularly about the longitudinal axis of the crankshaft. Bending vibration is similar to the bending of a cantilevered beam and occurs perpendicularly to the longitudinal axis of the crankshaft.

Additionally, many automotive vehicles suffer from unwanted noise, vibration, and harshness (“NVH”) resulting from other modes of engine vibrations. Unless controlled, torsional vibrations, bending vibrations, and other NVH leads to failure of the crankshaft and contributes to the failure of other engine parts.

For many years, the problem of torsional vibration has been recognized and a variety of devices have been constructed and used to reduce torsional vibrations, such as dampers. One common damper is a torsional damper having an inner metal hub attached to an end of the crankshaft, an outer metal annular member, and an elastomer member positioned between the hub and outer member (or “inertia member”). The inertia member is coupled to the hub by the elastomer and causes a phase lag between the oscillations of the hub and corresponding oscillations of the inertia member. Torsional dampers of this type are capable of reducing torsional vibrations, however are limited in overcoming axial shifting and bending vibrations. Additionally, conventional torsional dampers fail to cure NVH and reduce the resonance and magnification of NVH frequently occurring within the engine.

In recent years, other dampers have been proposed for reducing torsional and bending vibrations and increase the operating performance of engines. These dampers typically incorporate a torsional damper and a bending vibration damper into a single damper. A first inertia member is provided for damping the torsional vibrations, and a second inertia member for damping the bending vibrations. The torsional damper is generally of conventional construction with an annular inertia member connected to a hub through an elastomer member. The bending vibration damper comprises a second inertia member typically positioned radially inward from the first inertia member. The second inertia member is connected to the hub through a second elastomer member. Although this design addresses torsional and bending vibrations, the additional inertia member and elastomer member add unwanted weight and increase production costs of the damper. In addition, the dampener fails to cure the problems of NVH within the engine.

Other recent designs have attempted to cure the cost and weigh deficiencies by proposing a single mass dual mode damper with separate tuning capabilities for torsional and bending vibrations. One example of a single mass dual mode damper is disclosed in commonly owned U.S. Pat. No. 5,231,893 (“the '893 patent”), entitled “Dual Mode Damper”, which is hereby incorporated in its entirety by reference. FIGS. 1 and 2 illustrate an internal combustion engine 10 having a prior art damper 30 as set forth in the '893 patent. The engine 10 has multiple pistons 12 connected to a crankshaft 14. The pistons 12 move within the cylinders 16. Explosion of the gases within the cylinders 16 causes movement of the pistons 12 and, in turn, rotates the crankshaft 14. A distal end (not shown) of the crankshaft 14 may be connected to a transmission and drive train to drive the wheels of the vehicle.

The prior art damper 30 is connected to the crankshaft 14 to dampen and absorb torsional vibrations and bending vibrations. The damper 30 consists of a hub 32, an outer annular ring or inertia member 34, and an elastomer member 36 positioned between the hub 32 and the inertia member 34. As the crankshaft 14 and the damper 30 rotate, the elastomer member 36 acts as a barrier between the hub 32 and the inertia member 34 to slow the transition of forces between the hub 32 and the inertia member 34. The slowed transition results in a phase lag between the oscillations of the hub 32 and the corresponding oscillations of the inertia member 34, thereby dampening and absorbing torsional and bending vibrations.

While this design addresses torsional and bending vibrations, it is limited in preventing NVH and also can result in magnification of NVH, such as when the NVH vibrations overlay into the same frequency range as the damper hub. The problem can be exacerbated when peak resonance points of the damper hub are aligned and in phase with resonance points of the crankshaft and engine. Therefore, a need exists for a single mass dual mode damper that reduces torsional and bending vibration while also reducing NVH.

### SUMMARY OF THE INVENTION

It is an object of the present invention to provide a cost effective damper to reduce torsional vibrations and bending vibrations as well as other undesirable engine noises.

It is another object of the present invention to provide a single mass dual mode damper capable of separate and individual tuning of torsional vibration, bending vibration, and/or an additional axial set of vibrations without interference or magnification.

It is still another object of the present invention to provide a dual mode damper which can be assembled with existing tooling and use of existing techniques.

### DESCRIPTION OF THE DRAWINGS

Objects and advantages, together with the operation of the invention, may be better understood by reference to the following detailed description taken in connection with the following illustrations, wherein:

FIG. 1 illustrates an engine with a prior art vibration damper.

FIG. 2 illustrates a schematic cross-section of the vibration damper of FIG. 1.

FIG. 3 illustrates a single mass dual mode damper in an embodiment of the present invention.

### DETAILED DESCRIPTION

While the present invention is described with reference to the embodiments described herein, it should be clear that the present invention should not be limited to such embodiments. Therefore, the description of the embodiments herein is illustrative of the present invention and should not limit the scope of the invention as claimed.

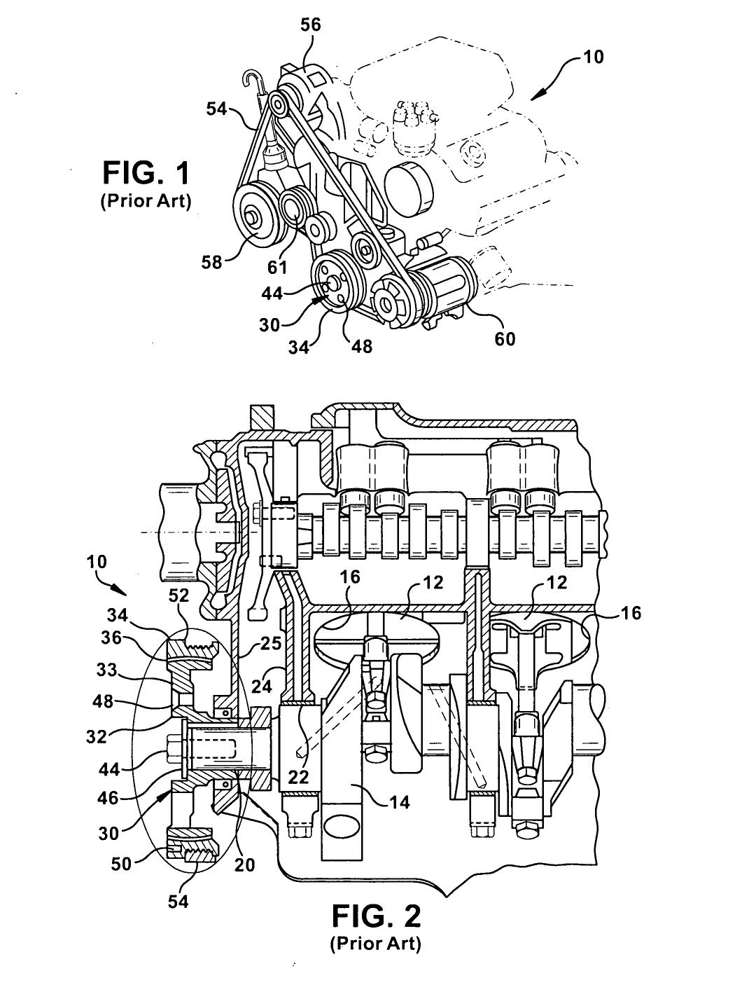

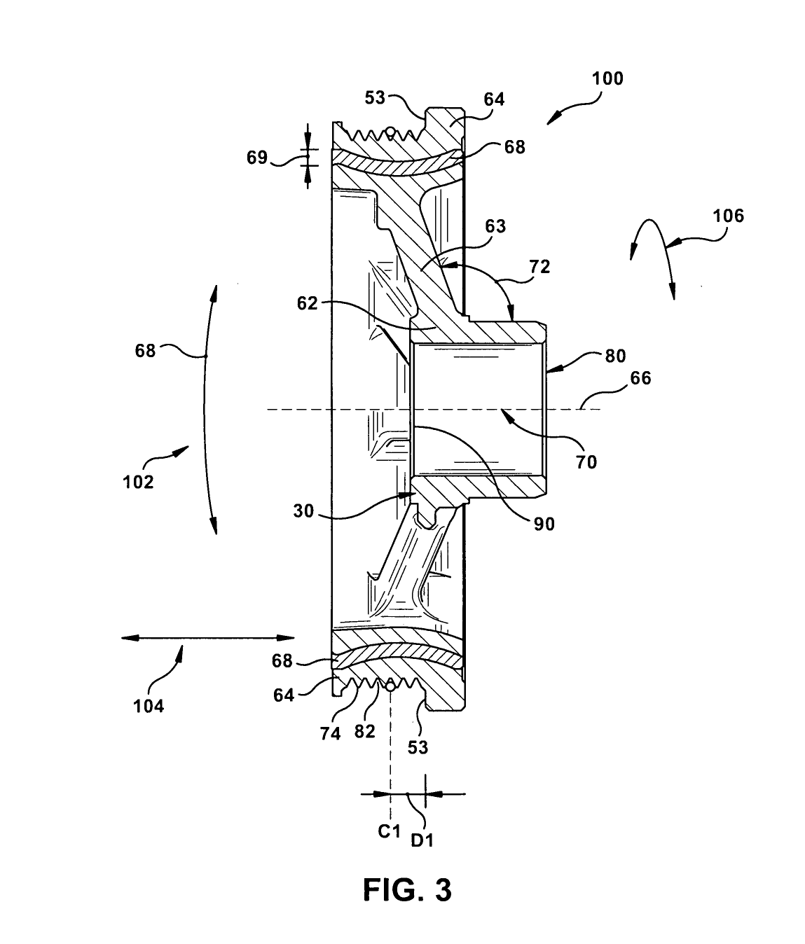

As illustrated in FIG. 3, a damper 100 is provided for dampening vibrations within an engine, such as the engine 10 of FIGS. 1 and 2. The damper 100 may have an opening 80 for attachment to a crankshaft, such as the crankshaft 14 of FIGS. 1 and 2, or other engine component. The damper 100 consists of an inertia member 64, a hub member 62, and a elastomer 68. The inertia member 64 may be spaced radially outward from the hub member 62. The elastomer 68 may be positioned between the hub member 62 and the inertia member 64. In an embodiment, the elastomer 68 is positioned under compression between the hub member 62 and the inertia member 64.

The inertia member 64, the hub member 62 and the elastomer 68 may be annular members capable of encircling or otherwise surrounding the crankshaft 14. The inertia member 34 may include a belt track 53 recessed in its outer surface for positioning of an engine belt, such as the engine belt 54 of FIGS. 1 and 2. As illustrated in FIG. 1, the engine belt 54 may drive other components of the engine 10, such as an alternator 56, a power steering compressor 58 and an air conditioning compressor 60. The belt track 53 of the intertia member 34 has a series of toothed ridges 74 and grooves 82 which may correspond in size and shape to grooves and ridges on the engine belt 54. Engagement between the engine belt 54 and the toothed ridges 74 and the grooves 82 of the intertia member 64 may aid in preventing the engine belt 54 from jumping, sliding or otherwise disengaging from the inertia member 64.

The hub member 62 may be spaced inwardly from the inertia member 64 with respect to the opening 80 of the damper 100. The crankshaft 14 may be inserted into the opening 80 of the hub member 62. To this end, the crankshaft 14 may be sized and shaped for engagement with the crankshaft 14. The crankshaft 14 may rotate about an axis 66 of the opening 80. In a preferred embodiment, the axis 66 is a center axis of the opening 80 and a center axis of the crankshaft 14.

The hub member 62 may be positioned on the crankshaft 14 by an interference fit. The hub member 62 may be keyed to the crankshaft 14 or secured via the bolt 44 and the washer 46 as shown in FIG. 2. A person of ordinary skill in the art will appreciate other manners of connecting the crankshaft 14 to the hub member 62.

As torque is applied to rotate the crankshaft 14, the crankshaft 14 may vibrate torsionally and generally perpendicularly with respect to the axis 66. The vibrations of the crankshaft 14 have numerous components. FIG. 3 illustrates an embodiment of various vibrations of the crankshaft 14. Bending vibrations 102, axial fluctuations 104 and torsional vibrations 106 are transmitted from the rotation of the crankshaft 14. The torsional vibrations 104 are generally angled with respect to the crankshaft axis 66.

The bending vibrations 102 are in a direction 68 generally perpendicular to the crankshaft axis 66, and the axial fluctuations 104 are generally parallel to the axis 66. Even if the bending vibrations 102 or other noise from the crankshaft 14 appear insignificant, minute displacement of the crankshaft 14 may be detrimental to the performance of the engine. For example, if the displacement of the crankshaft 14 due to the bending vibrations is on the order of 0.001-0.015 inches, then the resulting noise and deleterious effect on the crankshaft and other engine parts may still be significant.

The elastomer 68 is positioned between the hub member 62 and the inertia member 64. A bonding agent (not shown), such as “Chemlock” from Hughson Cements, a division of Lord Chemical, may be applied to the elastomer 68 prior to assembly of the damper 100. The bonding agent is preferably heat activated, and, after assembly of the damper 100, the damper 100 may be subjected to heat to cure or otherwise activate the bonding agent. Properly securing the elastomer 66 prevents the inertia member 64 and the hub member 62 from shifting relative to one another during use and maintains the position of the elastomer 68.

The thickness or cross-sectional area of the elastomer 68 is determined by the gap 69 between the hub member 62 and the inertia member 64. Of course, a person of ordinary skill in the art will appreciate that the thickness and cross-sectional area of the elastomer 68 may determine the gap 69 required between the inertia member 64 and the hub member 62. In an embodiment, the gap 69 of the elastomer 68 may range from 0.100-0.350 inches in width.

The elastomer 68 may consist of any elastic material, such as, a natural rubber or a synthetic elastomer. For example, the elastomer 68 may be made of styrene butadiene rubber, isoprene rubber, nitrile rubber, ethylene propylene copolymer, ethylene acrylic or a synthetic elastomeric composition as defined by specification SAE J200. The elastomer 68 is preferably in a state of radial compression between the hub 64 and the inertia member 62.

The selection of the size, type and mass of the elastomer 68 effects the ability of the damper 100 to reduce torsional vibrations 106 and bending vibrations 102. The damper 100 is preferably designed to correspond to a specific internal combustion engine having unique torsional and bending vibrations, as well as other vibrations and noise. The frequency of the bending vibrations 102 and the torsional vibrations 106 may be known from past experiences, determined experimentally, calculated using finite element analysis or otherwise determined in manners known to a person of ordinary skill in the art.

The elastomer 68 may be curved with respect the axis 66. For example, FIG. 3 illustrates an embodiment of the elastomer 68 having a convex curvature with respect to the axis 66. The amount and direction of curvature of the elastomer 68 depends on the bending vibrations 102 and the torsional vibrations 106 of the engine and the crankshaft 14. The convex curvature of the elastomer 68 increases the bending frequency of the damper 100 as the size of the gap 69 increases. The elastomer 68 may also be provided with a straight configuration that is substantially parallel to the axis 66 or an oppositely curved configuration that has a concave curvature with respect to the axis 66. The concave curvature generally decreases the bending frequency of the damper 100 as the size of the gap 69 increases. The bending vibrations 102 of the engine and crankshaft 14 may be known, determined experimentally, calculated or otherwise determined. For example, a non-curved elastomer 68 may have a torsional dampening frequency of 275 Hz and a bending dampening frequency of 450 Hz. The curvature of the elastomer 68 may improve dampening frequencies for bending vibrations 102 while maintaining the dampening frequencies for torsional vibrations 106.

Spokes 63 may extend from the hub member 62 toward the inertia member 64. In an embodiment, the damper 100 may have six of the spokes 63 equally spaced about the opening 80 of the hub member 62. As illustrated in FIG. 3, the spokes 63 may extend radially from the hub member 62 to the inertia member 64. In a preferred embodiment, the spokes 63 may be positioned such that the spokes 63 are located at the center of gravity of the elastomer 68. Unlike prior art dampers, such as the damper 30 of FIGS. 1 and 2, the spokes 63 are angled with respect to the axis 66.

The spokes 63 extend such that the inertia member 64 is a greater axial distance from a point 70 on the axis 66 than the hub member 62. The spokes 63 may allow a decrease in the mass of the hub member 62 while maintaining or even improving the support of the elastomer 68 and the engine belt 54. In addition, the spokes 63 and the geometry of the elastomer 68 allows an increase in the mass of the inertia member 64, if needed. In an embodiment, the portions of the spokes 63 and the portion of the inertia member 64 contacting the elastomer 68 may be subject to stress during operation of the damper 100 and, as a result, may flex during operation. The curvature of the elastomer 68 and the geometry of the spokes 63 may permit a stronger interia member 64, by increasing the mass of the portion adjacent to the elastomer 68.

In an embodiment, the crankshaft 14 may extend into the opening 80 and the inertia member 64 may extend beyond the end of the crankshaft 14 that terminates within the opening 80. The crankshaft 14 may be positioned within the opening 80 and approach or otherwise be positioned adjacent to a distal wall 90. A centerline C1 of the inertia member 64 may be offset a distance D1 from the end of the crankshaft 14. The distance D1 of the offset may depend on the frequency of the NVH, the bending vibrations 102 and the torsional vibrations 106. Offsetting the inertia member 64 from the distal wall 90 may prevent magnification or amplification of the NVH or other vibrations of the crankshaft 14. For example, the distance D1 may inherently yield frequencies out of phase with the NVH, bending vibrations 102 and the torsional vibrations 106.

The spokes 63 have an angle 72 with respect to the hub member 62. In a preferred embodiment, the angle 72 is greater than ninety degrees and less than one-hundred and eighty degrees. Advantageously, the spokes 63 allows positioning of the inertia member 64 at the distance D1 from end of the crankshaft 14. The angle 72 may be selected to yield a specific distance D1. Even for a specific distance D1, many angles 72 may yield the distance D1; however, other restrictions on the diameter of the hub member 62 may determine the minimum angle 72 required. For example, the damper 100 may be positioned adjacent to other engine components and, thus, may have a maximum diameter. In such an example, there is a minimum value for the angle 72 to yield the distance D1.

The spokes 63 may be integrally formed with the hub member 62. For example, the spokes 63 may be die cast or otherwise formed with the hub member 62. Alternatively, the spokes 63 may be attached to the hub member 62 and adjustable with respect to the hub member 62.

Noise, vibration and harshness, (“NVH”) is magnified when noise from the engine and the hub member 62 overlay into the same frequency range. This problem can be solved by structurally tuning the hub member 62 to a phase or frequency that is different from the phase or frequency range of noise from the engine.

The damper 100 may be tuned to produce dampening frequencies out of phase with the torsional vibrations 106, the bending vibrations 102 and the NVH of the engine and the crankshaft 14. The dampened torsional frequency and the dampened bending frequency may be changed based on the characteristics and properties of the damper 100. For example, tuning may be achieved by the selection of size, type, mass and geometry of the elastomer member 68, the hub member 62 and the inertia member 64.

In an embodiment, altering the geometry of the spokes 63, such as changing the angle 72 reduces NVH. Changing the angle 72 of the spokes 63 results in a modified dampening frequency for NVH. The angle 72 may be changed based on, for example, the peak resonance points of the engine and the crankshaft 14. Structural changes to the damper 100 may tune the peak resonance point of the hub member 62 such that it is out of phase with the peak resonance point of the engine 10 to reduce NVH. Radiated noise and magnification of NVH may be avoided by placing the peak resonance point of the hub member 62 above that of the engine 10 and the crankshaft 14. In addition to the angle 72, the mass of the hub member 62, mass of the inertia member 64, stiffness and other geometries may be varied in order to achieve the desired peak resonance point. Tuning the hub member 62 by varying the mass, stiffness and geometry may reduce NVH without affecting the torsional and bending damping characteristics of the damper 100.

As an example of use of the present invention, the frequency of vibrations of a specific engine and crankshaft 14 may be known from past experience, determined experimentally through dynamic testing, calculated by a computer using finite element analysis, or determined by another method known to a person of ordinary skill in the art. The elastomer member 68 of a certain material, size and cross-sectional area is selected to produce dampening bending vibrations out of phase with the bending vibrations 102, of the crankshaft 14. The curvature of the elastomer member 68 is adjust to sufficiently dampen or reduce the bending vibrations 102. The hub member 62 and inertia member 64 are configured to provide the gap 69 of size and shape to correspond to the cross-sectional area and curvature of the elastomer 68. The mass, stiffness and geometry of the hub member 62 and the inertia member 64 are selected. The angle 72 of the spokes 63 is determined to tune the damper 100 to a peak resonance point out of phase with the torsional vibrations 106, NVH and other noise of the engine. The hub member 62 and the inertia member 64 are formed and bonded to the elastomer 68. The damper 100 is positioned on and secured to the crankshaft 14.

The invention has been described above and, obviously, modifications and alternations will occur to others upon a reading and understanding of this specification. The claims as follows are intended to include all modifications and alterations insofar as they come within the scope of the claims or the equivalent thereof.

Having thus described the invention, the following is claimed:

1. A damper for tuning torsional and bending vibrations of an engine crankshaft, the damper comprising:
a hub having an opening for axial insertion of the crankshaft, the hub member rotatable about an axis;
an interia member spaced radially outwardly from the hub member;
an elastomer positioned between the hub and the inertia member; and
spokes extending from the hub member to the elastomer, the spokes extending at an angle greater than 90 degrees with respect to the axis.

2. The damper of claim 1 wherein the elastomer has a curvature with respect to the axis.

3. The damper of claim 2 wherein the elastomer has a convex curvature with respect to the axis.

4. The damper of claim 2 wherein the spokes have a curvature corresponding to the curvature of the elastomer.

5. The damper of claim 4 wherein the inertia member has a curvature corresponding to the curvature of the elastomer such that the elastomer is positionable between the spokes and the inertia member.

6. The damper of claim 1 wherein the inertia member is offset a distance from the hub member.

7. The damper of claim 1 wherein the inertia member is offset a distance from where the crankshaft secures to the opening of the hub member.

8. The damper of claim 6 wherein the elastomer is curved outward with respect to the axis.

9. The damper of claim 7 wherein the elastomer is curved with respect to the axis.

10. The damper of claim 7 wherein the elastomer is curved outward with respect to the axis.

11. A method of tuning a damper having an elastomer positioned between a hub member and an inertia member, the hub member having an opening capable of connection to a first end of a crankshaft of an engine, the method comprising the steps of:
determining noise, vibration and harness of the engine;
selecting the inertia member and the elastomer sufficient to dampen the noise, vibration and harness of the engine when the elastomer is positioned between the hub member and the inertia member;
determining an axial distance to offset the inertia member from the first end of the crankshaft; and
providing the hub member having a portion extending away from the opening such that the inertia member is offset the axial distance when the crankshaft and the inertia member are secured to the hub member.

12. The method of claim 11 further comprising the step of:
determining frequency of bending vibrations on the crankshaft of the engine; and
selecting the elastomer based on the frequency of the bending vibrations.

13. The method of claim 12 further comprising the step of:
determining an amount of curvature required to dampen the bending vibrations.

14. The method of claim 12 further comprising the step of:
determining frequency of torsional vibrations on the crankshaft of the engine; and
selecting the inertia member based on the torsional vibrations.

15. A damper for attachment to an end of a crankshaft of an engine, the damper comprising:
an annular hub member having an opening for securing the crankshaft;
an annular inertia member spaced radially outward from the hub member, the annular inertia member vertically offset from the opening of the hub member; and
an elastomer positioned between the hub member and the inertia member.

16. The damper of claim 15 wherein the hub member has spokes extending at an angle to vertically offset the inertia member from the hub member.

17. The damper of claim 15 wherein the elastomer is curved outward with respect to the hub member.

18. The damper of claim 15 wherein the elastomer is bonded to the hub member and the inertia member.
